(19) United States
(12) Patent Application Publication
(10) Pub. No.: US 2009/0201263 A1
(43) Pub. Date: Aug. 13, 2009

(54) Golf course management system for golf carts

(76) Inventor: James Herbert Hofmann, Escondido, CA (US)

Correspondence Address: James Hofmann, 10303 Oak Ranch Lane, Escondido, CA, 92026, US

(21) Appl. No.: 12/322,888

(22) Filed: Feb. 9, 2009

Related U.S. Application Data
(60) Provisional application No. 61/063,908, filed on Feb. 8, 2008.

(51) Int. Cl. G06F 3/041

(52) U.S. Cl. 345/173

(57) ABSTRACT

The present invention relates to a golf course management system for golf carts. The system includes a touch screen display device and a processor communicatively connected with the touch screen display device. The processor includes a global positioning system is configured to determine a location of the golf cart on a golf hole; display an image of a golf hole; display a location of the golf cart on the golf hole; receive a first touch location on the touch screen display device and calculate the corresponding distance on the golf course between the golf cart and the first touch location; and receive a second touch location on the touch screen display device and calculate the corresponding distance on the golf course between the first touch location and the second touch location.

### PRIORITY CLAIM

The present application is a Non-Provisional patent application, claiming the benefit of priority of U.S. Provisional Application No. 61/063,908, filed on Feb. 8, 2008, entitled, “Touch screen GPS for golf cart.”

### BACKGROUND OF THE INVENTION

(1) Field of the Invention

The present invention relates to a golf course management system and, more particularly, to a touch screen display integrated with a global positioning system for assisting a user in managing play while on a golf course.

(2) Description of Related Art

Golf course management is a procedure by which a golf course administrator can monitor and manage the play on the course while individual golfers can analyze the course and manage their individual play. While managing play, it is advantageous to have a golf management system incorporated into the individual golfer's golf cart. Further, through use of a global positioning system (GPS), the golf course administrator can monitor the golfer's actual real-time position while individual golfers are able to manage both their actual position and play while on the golf course.

There are a very limited number of vendors in the market place today that provide golf cart-based GPS functionality. For example, one vendor provides a monochrome system that displays limited information to the user in terms of front, center, and back yardages to the green from the cart mounted unit. Two other vendors provide large liquid crystal display (LCD) screens that provide the golfer with front and back-of-green yardages. In all existing systems, physical buttons are used to query the system to move from screen to screen, thereby eliminating interaction with fairway and green images. Additionally, existing systems utilize pre-determined latitude/longitude locations that provide ever present on-screen yardages to hazards, sand traps, and other points of interest. Generally speaking, there are usually only four such pre-determined latitude/latitude locations per golf hole. These limitations deny the golfer the ability to practice “course management.” Furthermore, the ever present yardages on the screen tend to clutter the images with numeric text, causing confusion and most likely selection of a golf club that is suited for a different distance at a selected target. Another issue arises due to individual golfers' various skill levels as the pre-determination of selected points of interest will not be suitable for all skill levels. For example, handicaps vary greatly and each golfer makes yardage decisions based upon their particular skill level.

All golf holes, by design, have unique characteristics. For example, one hole may have numerous sand traps while another hole may have a dog leg left or right, while another hole may have water hazards crossing the fairway in one or two locations. Thus, each golf hole has a variety of actual points of interest; however, existing products usually cover only four points of interest. Consequently, the existing products fall far short of allowing a golfer, based on their particular skill level, to determine an unlimited number of locations that their golf ball may come to rest.

Thus, a continuing need exists for a course management system that allows a user to monitor their own position within a golf course while analyzing the play from the user's own position in an image of the golf course. Further, a need exists for a system that provides a specific latitude/longitude for every pixel on the image, thereby providing distance accuracy to any location selected by a golfer on the image.

### SUMMARY OF INVENTION

The present invention is a golf course management system for golf carts that allows for a more informed round of golf for both golfers and golf course managers (i.e., the Pro Shop, etc.). The system is configured to be attached with a golf cart to assist users in managing play while on a golf course. It should be understand that the system includes a touch screen display device and one or more processors that are communicatively connected with the touch screen display device. This unit package (i.e., the touch screen display device and processor(s)) is formed to be attached with a golf cart. While the system can be a standalone device, it can also be expanded to include a plurality of units, each of which is attached with a golf cart. Further, the system also includes a Pro Shop administrative unit (with both a display and processor(s)) that can communicate with each of the units attached with the golf carts.

In another aspect, the processor(s) includes a global positioning system (GPS) (or are connected with such a GPS system). Additionally, the processor is configured to determine a location of the golf cart on a golf hole; display an image of a golf hole; display a location of the golf cart on the golf hole; receive a first touch location on the touch screen display device and calculate the corresponding distance on the golf course between the golf cart and the first touch location; receive a second touch location on the touch screen display device and calculate the corresponding distance on the golf course between the first touch location and the second touch location; and display both the distance between the golf cart and the first touch location and the distance between the first touch location and the second touch location to a user on the display device, thereby allowing a user to determine shot distance and manage play on the golf course.

In yet another aspect, the image of the golf hole is an actual aerial image of the golf hole.

Additionally, the processor is further configured to display a plurality of tee boxes, each tee box representing an actual tee box on the golf hole; receive a selection from a user designating one of the plurality of the tee boxes as a selected tee box; calculate a distance from the selected tee box to a pin hole; and display the distance to the user.

In yet another aspect, the one or more processors are further configured to receive input from a plurality of users designating a golf ball drive location for each of the plurality of users from a designated tee box; calculate a distance between the designated tee box and the golf ball drive location for each of the plurality of users, the distance being a driving distance; and select the longest driving distance and display the longest driving distance to each of the plurality of users in their corresponding display devices. It should be understood that the one or more processors refer to the processors attached with the golf carts and/or the Pro Shop administrative unit. These functions can be performed individually or across the processor units. As a non-limiting example, the units attached with the golf carts can receive input from a user designating a golf ball drive location and transmit (via a transceiver (e.g., RF or other suitable device) the drive location to the Pro Shop administrative unit. The Pro Shop administrative unit can receive the golf ball drive locations (from the units attached with the golf carts), calculate the driving distances, select the longest driving distance, and transmit the longest driving distance back to the units attached with the golf carts, which then display the longest driving distance to the users. As yet another non-limiting example, each of the golf cart units can calculate the driving distances, which are then transmitted between all of the golf cart units, which collectively determine and then each display the longest driving distance. As yet another non-limiting example, each of the golf cart units can calculate the driving distances which are then transmitted to the Pro Shop administrative unit. The Pro Shop administrative unit then determines the longest driving distance and transmits the longest driving distance back to each of the golf cart units. Each of the golf cart units then display the longest driving distance.

In another aspect, the one or more processors are further configured to receive input from a plurality of users designating a golf ball drive location for each of the plurality of users from a designated tee box to a particular pin hole; calculate a distance between the golf ball drive location for each of the plurality of users and the particular pin hole, the distance being a distance-to-pin; and select the shortest distance-to-pin and display the shortest distance-to-pin to each of the plurality of users in their corresponding display devices. Again, these functions can be performed individually or across the processor units.

Finally, the present invention also includes a method and computer program product. The method includes a plurality of acts of performing the operations described herein while the computer program product comprises computer-readable instruction means stored on a computer-readable medium that are executable by a computer having a processor for causing the processor to perform said operations.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a block diagram depicting the components of a golf course management system of the present invention;

FIG. 2 is an illustration of a computer program product embodying the present invention;

FIG. 3 is an illustration of a golf cart, depicting a golf course management system attached with the golf cart;

FIG. 4 is an illustration of an aerial photograph of a golf hole depicting the typical configuration of tee boxes, fairway, hazards, and a green;

FIG. 5 is an illustration depicting a golf cart situated at a tee box with yardage distance being displayed after touching the location of a hazard in the fairway;

FIG. 6 is an illustration of a golf cart situated on a cart path where the golfer has touched the location where their golf ball is, displaying that yardage, and then touching a second location displaying the yardage between the first and second touch (i.e., the second touch is generally the desired target);

FIG. 7 is an illustration depicting the location of the golf cart next to a golf ball that has been driven down the fairway while displaying the drive distance;

FIG. 8 is an illustration depicting the selection of a third tee box and a location of the golf cart next to a golf ball that has been driven down the fairway, while displaying the drive distance from the chosen tee box;

FIG. 9 is an illustration depicting the location of a golf cart next to the driven golf ball and touching a pin location on the green displaying the yardage from the golf ball to the pin location;

FIG. 10 is an illustration of a touch on the magnifying glass to display a zoomed image of the green and touching a pin location resulting in a yardage display of yardage between the cart location and pin location;

FIG. 11 is an illustration of the golf cart situated behind a tree rendering an inability of a golf shot straight to the green, thereby requiring a pitch out to the fairway on a first touch to the fairway along with yardage, and a second touch to the green which displays the yardage from the first touch to the second touch;

FIG. 12 is an illustration of a method of teaching “golf course management” by a professional, wherein the first touch is a location that is short of a water hazard and a second touch to a layup in front of a hazard in front of the green;

FIG. 13 is an illustration of a pro shop liquid crystal display (LCD) for longest driving contests as conducted during tournament outings;

FIG. 14 is an illustration of a pro shop LCD display for a “closest-to-the-pin” contest and entering feet and inches of distance of a golf ball to the pin;

FIG. 15 is an illustration depicting a full screen advertisement;

FIG. 16 is an illustration of an electronic scorecard;

FIG. 17 is an illustration that provides a button to migrate to the illustration in FIG. 18 and allowing golfers to record their shot distance relative to the golf club used to advance the golf ball;

FIG. 18 is an illustration depicting a user recording a shot;

FIG. 19 is an illustration of a data input screen;

FIG. 20 is an illustration of a utility screen for use by administrative personnel;

FIG. 21 is an illustration of a “HELP” screen detailing functional characteristics; and

FIG. 22 is an illustration of another “HELP” screen that provides additional explanations of various system functions.

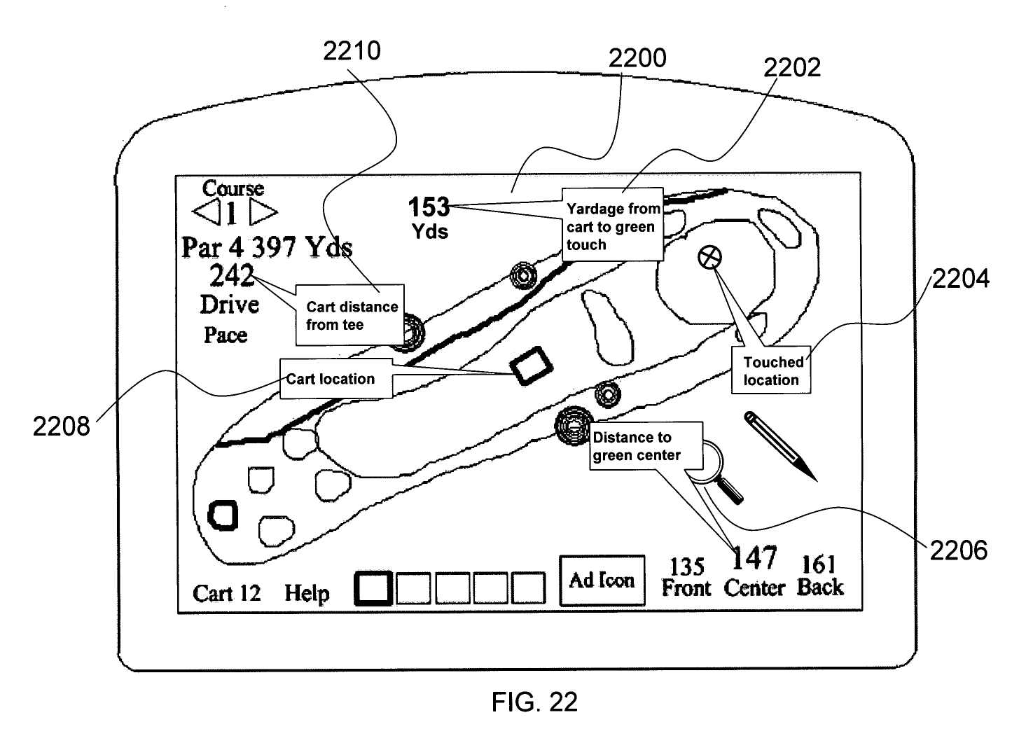

### DETAILED DESCRIPTION

The present invention relates to a golf course management system and, more particularly, to a touch screen display integrated with a global positioning system for assisting a user in managing play while on a golf course. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, first a description of various principal aspects of the present invention is provided. Subsequently, an introduction provides the reader with a general understanding of the present invention. Next, details of the present invention are provided to give an understanding of the specific aspects. Finally, a summary is presented.

(1) Principal Aspects

The present invention has three “principal” aspects. The first is a golf course management system. The golf course management system is typically in the form of a computer system operating software or in the form of a “hard-coded” instruction set. This system may be incorporated into a wide variety of devices that provide different functionalities. The second principal aspect is a method, typically in the form of software, operated using a data processing system (computer). The third principal aspect is a computer program product. The computer program product generally represents computer-readable instruction means stored on a computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. These aspects will be described in more detail below.

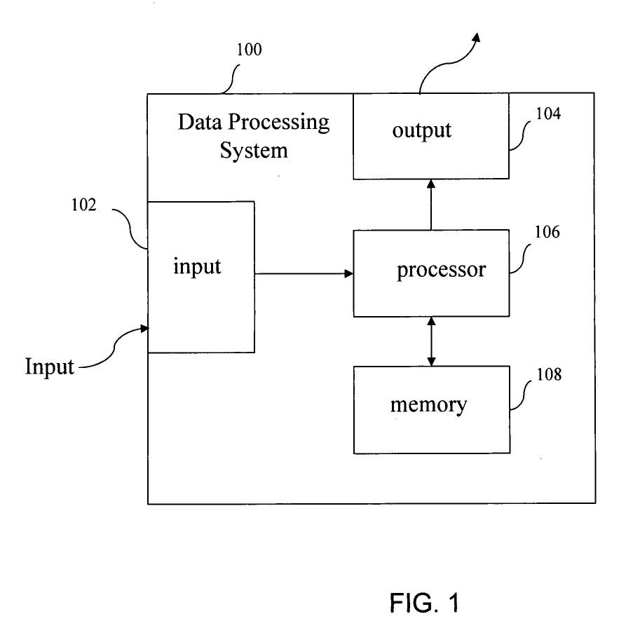

A block diagram depicting the some of the components of a golf course management system of the present invention is provided in FIG. 1. The golf course management system 100 comprises an input 102 for receiving information from a user or users, such as through a touch screen display or a Pro Shop management system. Note that the input 102 may include multiple “ports.” Typically, input is received from at least one user, from a global positioning system, or through a transmission from the Pro Shop management system. An output 104 is connected with the processor or processors for providing information to a user or to other systems in order that a network of computer systems may serve as a golf course management system. Output may also be provided to other devices or other programs; e.g., to other software modules, for use therein. The input 102 and the output 104 are both coupled with a processor (or processors) 106, which may be a general-purpose computer processor or a specialized processor designed specifically for use with the present invention. The processor 106 is coupled with a memory 108 to permit storage of data and software that are to be manipulated by commands to the processor 106.

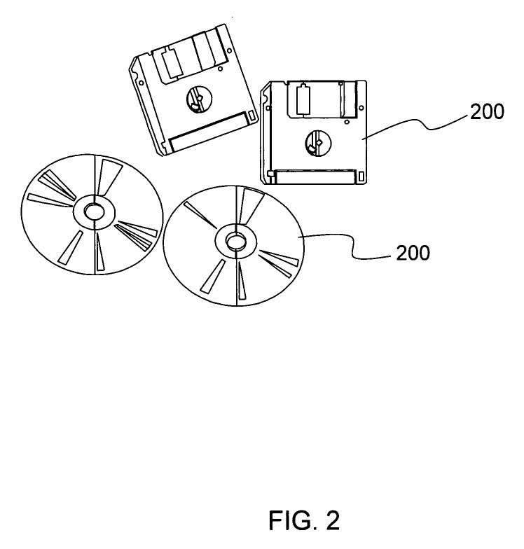

An illustrative diagram of a computer program product embodying the present invention is depicted in FIG. 2. The computer program product 200 is depicted as an optical disk such as a CD or DVD. However, as mentioned previously, the computer program product generally represents computer-readable instruction means stored on any compatible computer-readable medium. The term “instruction means” as used with respect to this invention generally indicates a set of operations to be performed on a computer, and may represent pieces of a whole program or individual, separable, software modules. Non-limiting examples of “instruction means” include computer program code (source or object code) and “hard-coded” electronics (i.e. computer operations coded into a computer chip). The “instruction means” may be stored in the memory of a computer or on a computer-readable medium such as a floppy disk, a CD-ROM, and a flash drive.

(2) Introduction

The present invention is a golf course management system for golf carts that allows for a more informed round of golf for both golfers and golf course managers (i.e., the Pro Shop, etc.).

First discussed is the improved method of informing golfers during a round of play. Historically, there have been a number of attempts to inform golfers to provide a more pleasant round of golf. Paper scorecards typically provide yardage information for tee to green distances, the established handicap for each hole (which is determined by professionals basing the handicap on difficulty of play) and, on occasion, “tips” on what to be aware of on given holes. Tips often include hazards to avoid, preferred landing spots to hit a golf ball, and graphical drawings that display the layout of each hole. More recently golf courses have installed yardage labels on sprinkler heads indicating the distance from the sprinkler head to the center of the green. While this has provided significant assistance for determining distance, it only suffices for that given sprinkler head. Golfers then “step off” distances to the location where the golf ball came to rest to determine club selection. One can readily see that such activities increase the amount of playing time. Even marginally skilled golfers use that method to determine club selection. The method is often repeated which further delays play time. This method is often noticeable during tournament play when a caddie can be observed pulling a detailed golf hole map out of their pocket and then stepping off the distance from locations seen on the golf hole map.

In the 1990's when a global positioning system (GPS) was made available to the public, several companies brought a device to the market place that provided a liquid crystal display (LCD) screen mounted under the roof of golf carts that displayed graphical presentations of golf holes. The images provided yardages from specific landmarks, such as bodies of water, sand traps, and distances to the green from the golf cart position.

The current system improves upon the prior art through the utilization of an LCD touch screen display device in combination with a variety of enhanced features. To further illustrate the advantages of the present invention, a typical round of golf utilizing a system according the present invention is presented. It should be understood that the example provided below is for illustrative purposes only and that the invention is not intended to be limited thereto.

Upon paying a green fee and cart rental fee, golfers will place their clubs on a golf cart and position themselves in the cart. Through the display device, golfers will be presented with a full screen advertisement that can either be touched to display information about the course or, when the cart approaches a tee box, automatically displays the image of a golf hole. The image can be a rendering or an actual aerial view of the golf hole.

When approaching a tee box, a golfer can either use the default tee box or select an alternative tee box which will then become the default tee box for each succeeding hole. The display device is mounted to the steering column (or any other suitable location on the golf cart) with the enclosure being located directly to the side (e.g., right side) of the steering wheel. There are two views presented to the golfer, the image of the hole on the screen and an actual view of the hole in front of the golf cart. Although a hazard or other such feature of the golf hole may not actually be seen by the golfer, the golfer can view the screen that displays an aerial image of the hole. Through the aerial image, the golfer will readily see hazards and every feature of the hole. To assist the golfer in analyzing the golf course, simply touching a feature on the screen will instantly provide a yardage to the selected feature.

After teeing off and returning to the cart, a full screen advertisement will be displayed by the sponsor of that hole. The golfer can either touch the screen to display the golf hole (causing the advertisement to disappear or be reduced) or the advertisement will automatically disappear after driving a predetermined distance (e.g., thirty yards) from the selected tee box. In typical play, the cart will most likely be driven to the golf ball that rests in a location that is closest to the tee box. After reaching the location of the ball, the display device provides the golfer with at least four different yardages (i.e., the driving distance from the tee box to the current cart location, the distance from the current cart location to the front, center, and back of the green).

The vista in front of the golfer is matched by the screen image and the golf hole itself. From that vantage point, the golfer can touch (on the display device) any feature and instantly get the distance from the cart to the touched location. If the front, center, or back yardage exceeds the skill level of the golfer, a first touch can be used to display a distance that is achievable and a second touch (i.e., “double touch”) to instantly determine the distance between the two touches. The golfer has the option to touch a magnifying symbol that zooms the screen to a detailed view of the green for a precise desired location to hit the ball. After the ball has been struck, the cart will proceed to the next driving location where the process can be repeated.

Other conditions exist that would require the use of the “double touch.” For example, if a ball came to rest behind an object that doesn't permit a straight shot to the green or other desired location, the golfer can touch a location to pitch the ball to and a second touch to a desirable location. Another example exists during a “cart on path” condition because of adverse fairway conditions. In both examples, the golfer can drive the cart to a position where the golf ball can be seen from the cart, enabling the golfer to touch that location and then provide a second touch to the desired location.

After both players have executed their approach shots to the green and the cart is a predetermined distance (e.g., fifty yards) from the green, the scorecard will automatically appear. If the golfers want to display the scorecard voluntarily, they can touch the scorecard icon for the scorecard display. Thus, when the golfers have completed their putts and returned to the golf cart, they can easily enter scores by touching the specific matrix location on the scorecard. A numeric keypad is then presented to allow the golfers to touch the number that represents the number of strokes used for the golf hole. When the cart starts to move after recording the scores, a full screen advertisement appears for the sponsor of the succeeding hole and the process is repeated.

As mentioned earlier, the method of using sprinkler head yardages versus the method according to the present invention will result in a reduced playing time. For example, it has been found that the present invention can reduce the playing time by up to two minutes per hole. Golf course managers that do not have a GPS system to aid in efficient operations typically rely upon “marshals/rangers” that communicate with the pro shop and that tour the course to admonish golfers that don't have a good “pace of play” regimen. It only takes one group (e.g., a foursome) to slow down an entire day's play. Most golf courses have an interval of eight minutes between tee times. If a group falls behind by, for example approximately 30 minutes, and the golf course has booked tee times that fill the days schedule, there is a potential to lose four tee times due to the slowed “pace of play.”

The present invention provides golf cart positions periodically (e.g., every minute) or constantly for each cart, whether in use or not. Each cart in play is polled for position reporting as well as other data reporting, such as scorecard information. The position of each cart along with the corresponding cart number is automatically displayed on a large Pro Shop display that allows the user to zoom in on any area of concern on the overall aerial image of the entire golf course. The cart icons are color coded to differentiate players that are on the established “pace of play,” usually around four to four and a half hours a round, from those that are not. Messages can be sent automatically to violating carts or they can be sent by someone that is able to monitor the Pro Shop display. As previously mentioned, a group that falls behind by 30 minutes could cause the course to lose 4 tee times on any given day. Such a delay could potentially affect the green fees for 16 golfers. Historically, when course management has been marketed by the limited number of GPS vendors, they have been reluctant to pay the high prices simply because the return on investment is not an assured condition. The “Advertising Revenue Sharing” and the discreet “pace of play” monitoring as provided by the present invention virtually assures course management an excellent return on investment.

(3) Details of the Invention

As noted above, the present invention is a golf management system for golf carts. Before describing the invention in detail, it should be understand that although various examples and measurements are provided below, the invention is not intended to be limited thereto. For example, the use of yardage, feet, and inches is for illustrative purposes only as the present invention can be used with any measurement system, including the metric system, etc. Additionally, the description below provides various scenarios in which a golfer or operator performs various operations using the present invention. It should be understood that the present invention is configured, using an appropriate system (including a processor and touch screen display), to perform the operations described herein.

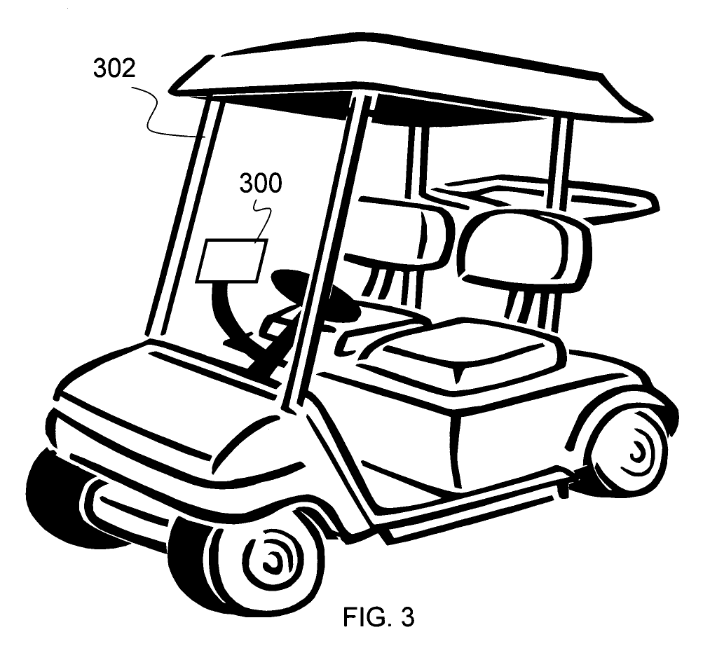

For example and as illustrated in FIG. 3, the system includes a touch screen display device 300 that can be connected with a golf cart 302, a non-limiting example of such a touch screen display device 300 is a liquid crystal display (LCD) touch screen. The touch screen display device 300 operates as a golfer-side interface to allow the golfer to easily engage the touch screen. The display device 300 is connected with a data processing system (depicted as element 100 in FIG. 1) that is configured to perform the operations described herein.

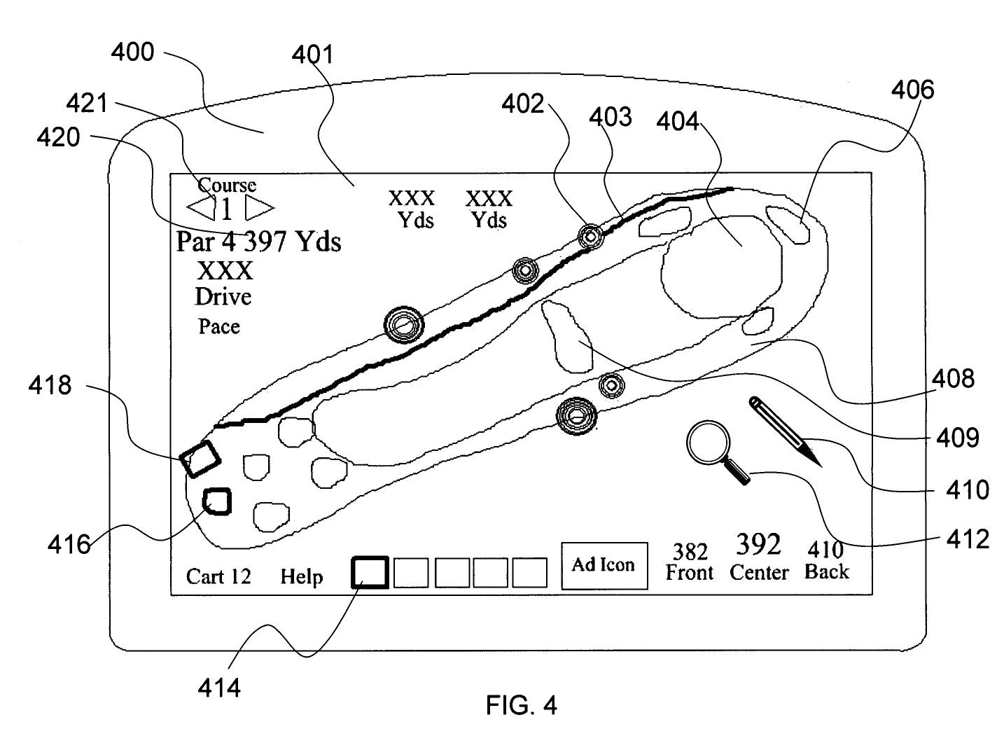

FIG. 4 provides an illustration of such a touch screen. For example, the display device includes an enclosure 400 that houses an LCD touch screen display 401 that displays an image of a golf hole and a variety of features on the golf hole. Non-limiting examples of such features include a tree 402, a golf green 404, sand traps 406, a fairway 408, a hazard 409, and tee boxes 416.

The image of the golf hole is any suitable image that depicts the hole. As a non-limiting example, the image of the golf hole is a cartographic image that uses an aerial photograph of each fairway and green that is supplemented with geographical data, allowing each point to be precisely located in latitude and longitude. For example, the data includes the location of the upper left corner of the image and vectors describing the direction and distance from the upper left corner to the upper right corner, and the upper left corner to the lower left corner.

The image is positioned on the screen of the display 401 in any suitable configuration, a non-limiting example of which includes the tee boxes being depicted in the lower left corner with the green in the upper right corner. 7. Thus, the system include programming that provides for the capability to carve out golf hole images from an aerial image of an entire golf course, rotate the image from its true north/south orientation, and fit the image on the display at a lower left to upper right position while keeping true latitude/longitude integrity.

Additionally, the fairways and greens can be depicted through various color and/or shading representations. As a non-limiting example, in the images of fairways and greens, the area comprising the fairway is lightened in color enough to distinguish it from the surrounding area (the “rough”). Alternatively, the area comprising the green is lightened still further in order to distinguish it from the fairway and the rough.

When a golf cart 418 enters the tee box area, usually on a cart path 403, the golfer brings the cart to a stop adjacent to the tee box area. Each golf hole has a pre-marked latitude/longitude location that is recognized by the system and causes the golf cart icon 418 to appear on the hole image. In operation, the system receives the latitude and longitude information from an onboard GPS unit which then displays a golf cart icon 418 on the screen to indicate the location of the cart on the image of the fairway or green.

Visible at the top left of the screen is a hole number 421 and arrow symbols that permit the golfer to go forward or backwards to other golf hole images. The display device also displays the yardage distance 420 to the center of the green along with the established par. Additionally, the yardage distance can be calculated and displayed for the distance between the selected tee to the cart and from the cart to the center, front, and back of the green. Such distances can be selectively displayed or displayed at all times.

If the golfer selects a different tee box, the display will change to the yardage for that particular tee box to the pin. Distances displayed are representative of the hard copy scorecard (but can be altered by the Pro Shop to reflect course repair, etc.). The system is set to default to the number one tee box 416 as highlighted by symbol 414. Users (i.e., golfers) can choose any of the color coded tee boxes that color corresponds to colors displayed on regular hard copy scorecards (and/or that corresponds to the actual tee box colors on the hole). In other words, icons are provided for each tee of differing difficulty maintained by the course. Touching an icon displays a marker of the same color at the location of that tee on the fairway image. At the same time, the actual yardage of the hole for that tee and the par are displayed.

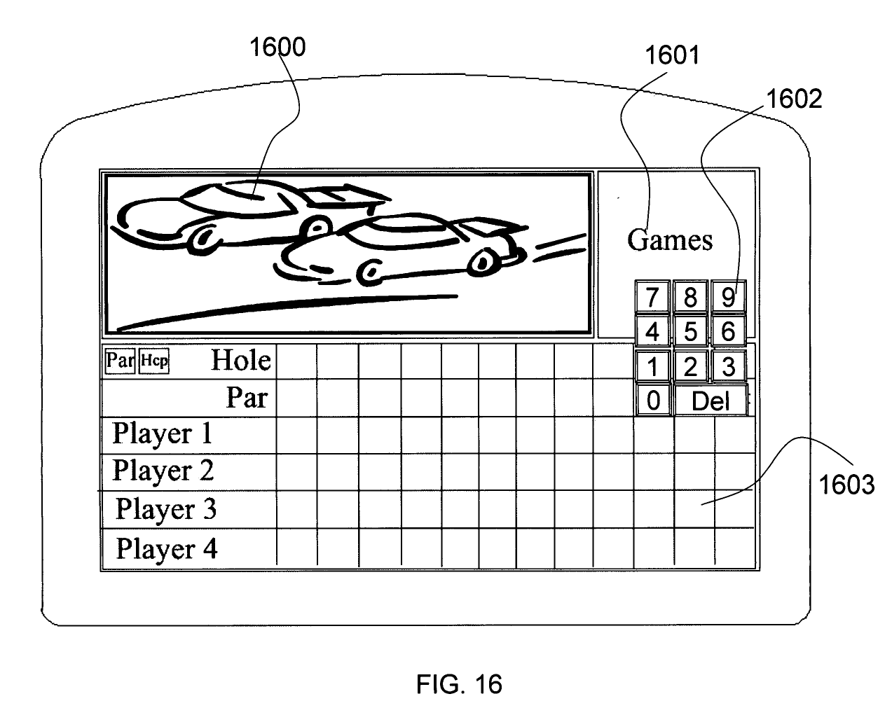

As can be appreciated by one skilled in the art, additional touch locations can be provided on the touch screen to cause the system to change screens to provide the user with additional screens and features. As a non-limiting example, the scorecard symbol 410 is a touch location that takes the golfer to an electronic scorecard screen, depicted as element 1600 in FIG. 16. As yet another non-limiting example, a magnifying symbol 412 takes the golfer to a zoomed green screen that provides a close-up view of the golfer's location on the hole.

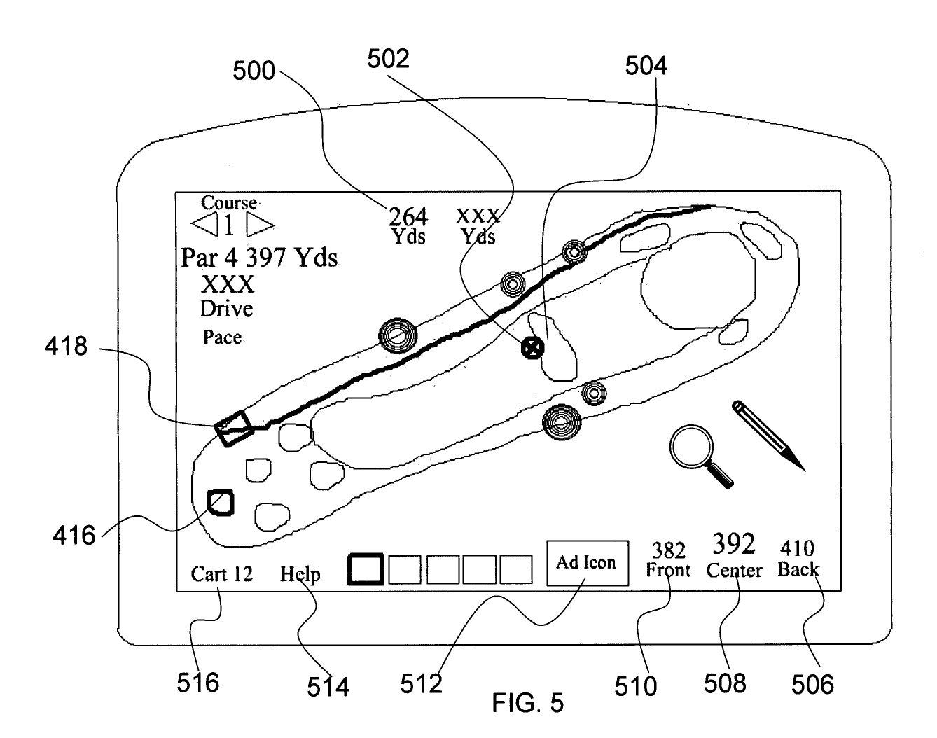

FIG. 5 displays the cart 418 adjacent to the selected tee box 416. In the distance, both on the touch screen display 401 and the actual golf hole, the golfer sees a body of water 504. When the location 502 (e.g., adjacent to or at the location of the body of water 504 on the display 401) is touched, the display 401 instantly displays the yardage 500 between the golfer's current position and the location 502 that is depicted on the display. More specifically, if a golfer wanted to know the distance between their current position (indicated by the cart 418) and the body of water 504, the golfer would simply touch the image of the body of water 504 on the display 401, which results in the calculation and presentation of the yardage 500. The golfer now knows if he hits his drive more than 264 yards (i.e., as indicated by the yardage 500) the ball will most likely get wet. In addition, the display 401 indicates the distance between the cart 418 and the back of the green 506, the center of the green 508, and the front of the green 510.

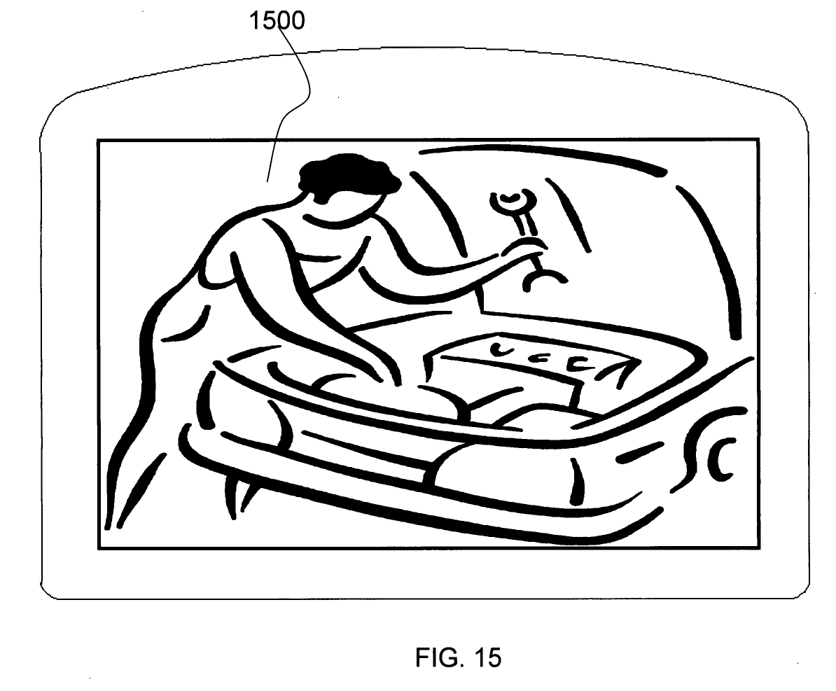

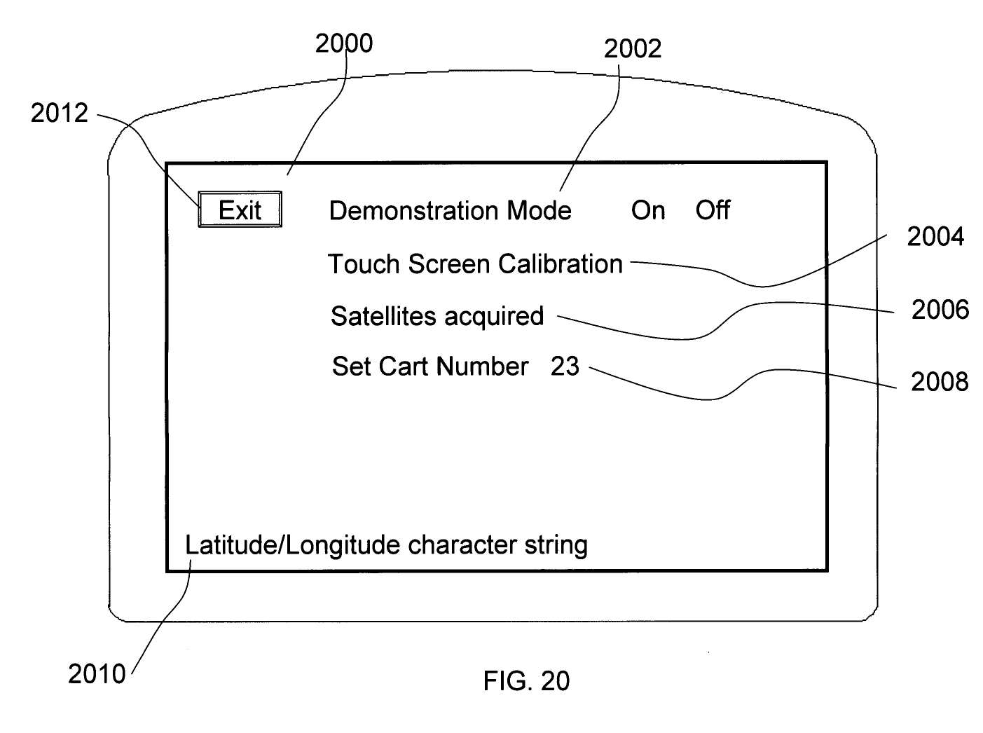

The Ad Icon 512 is a touch location that switches the screen to the image shown in FIG. 15. The Ad Icon 512 refers to an advertisement and is used to allow users to see the full screen or enhanced screen of a particular advertisement, as depicted in FIG. 15. Additionally, golfers are provided with a “Help” screen via touch location 514. The “Help” screen can be used to provide the golfers with directions and additional functionality of the system. Additionally, the “Help” screen can be used to alert the Pro Shop of an emergency or the necessity for help, such as a broken cart, medical illness, etc. The cart number 516 identifies the actual cart number that is displayed on the side of each golf cart. The cart number 516 is also displayed on the utility screen as used by an administrator (depicted in FIG. 20). Each cart includes both a GPS system and a radio frequency (RF) transceiver (or other suitable transceiver device) that transmits golf car position, speed, and direction to base station (i.e., Pro Shop) that is time stamped.

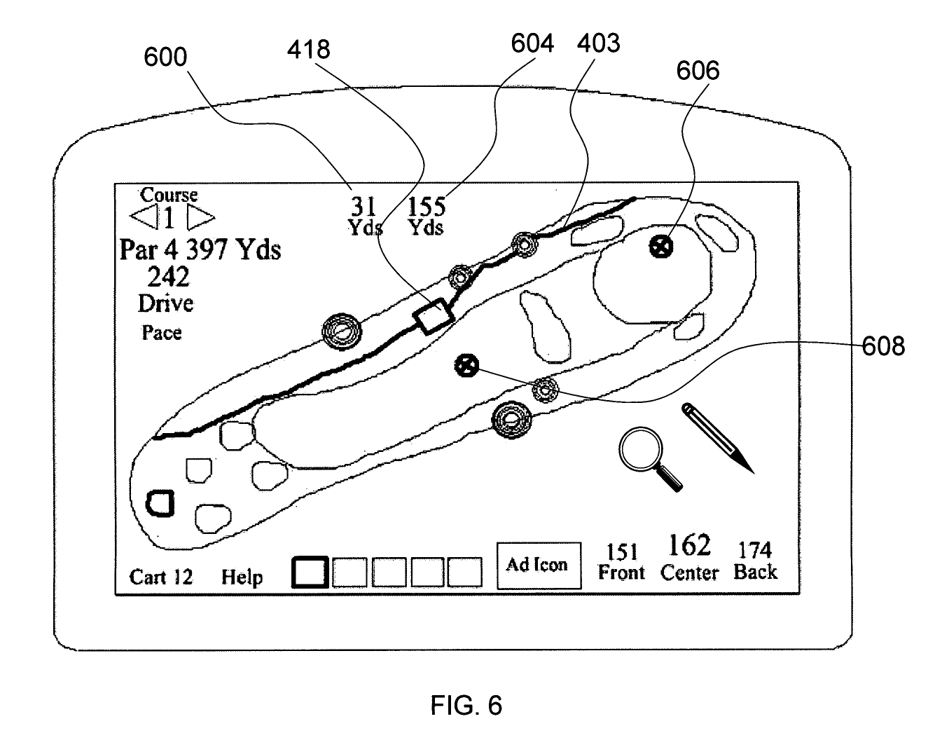

FIG. 6 illustrates a “carts on path” condition. Generally, a “carts on path” condition is caused by wet fairways that can be damaged by a cart permitted to be driven on the fairway. When a golfer carries more than one club to the ball position he has to lay the other clubs down on the grass which will cause an undesirable condition of wet grips. If the golfer takes only one club out to the ball position, he most likely will have to return to the cart to get a different club. This kind of action slows “pace of play” considerably and causes the golfers behind him discomfort. The present invention addresses the “cart on path” condition by allowing a golfer to determine the distance between where the golf ball lays and the pin (or any other location on the golf course). For example, FIG. 6 depicts the position of the cart 418 on the cart path 403. In this non-limiting example, the golfer has driven his ball to touched location 608. The distance between the car 418 and the touched location is displayed as 600. To assist the golfer in knowing which club to select before walking out to the fairway to strike the ball to a pin location 606, the golfer can touch the desired location 606 and instantly receive a display of the yardage 604 between touch 608 and touch 606. As noted above, without this function, the golfer will usually carry two or three clubs to the ball location to assure himself of having the right club.

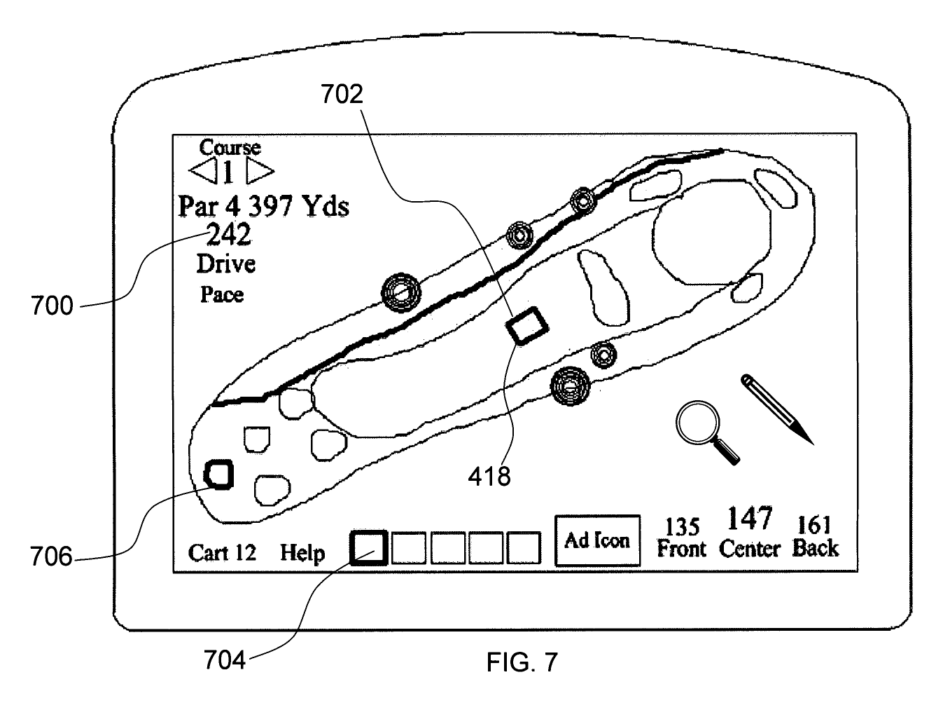

FIG. 7 illustrates driving distance. For example, a golfer can drive the cart 418 to the ball position 702. The driving distance 700 is displayed from the previous stop point (or from the tee box) to the new ball position 702 (as touched on the display by the golfer or as determined by the location of the cart 418). The driving distance 700 can be determined by the distance between two touch points or through any other suitable technique. In other words, a golfer can select a tee box through the tee box selection 704 icon which causes the system to calculate and display the distance (i.e., the driving distance 700) between the selected tee box 706 and the cart 418. This calculation can be done immediately regardless of distance from the tee box 706 or after the cart 418 has moved a predetermined distance from the tee box 706. For example, the system can be configured to calculate and display the driving distance 700 after the cart 418 is in excess of one hundred yards from the location of the selected tee box 706; this aspect does not require the user to touch two points but simply requires tee box selection and movement of the cart 418 a predetermined distance from the selected tee box 706.

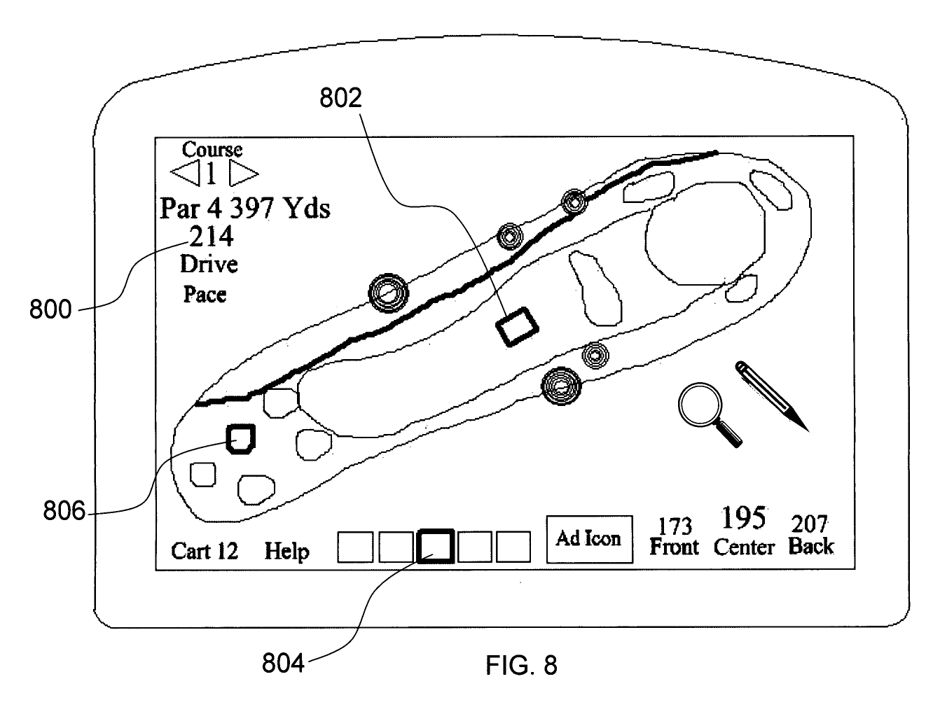

FIG. 8 illustrates how two players riding in the same cart that tee off from different tee boxes can determine Player 2 driving distance merely by touching tee box selection 804 instantly displaying driving distance 800. Cart position 802 represents the ball driven by the second player. By touching tee box icon 804, the actual tee box location 806 lights up with the representative color code of that tee box location.

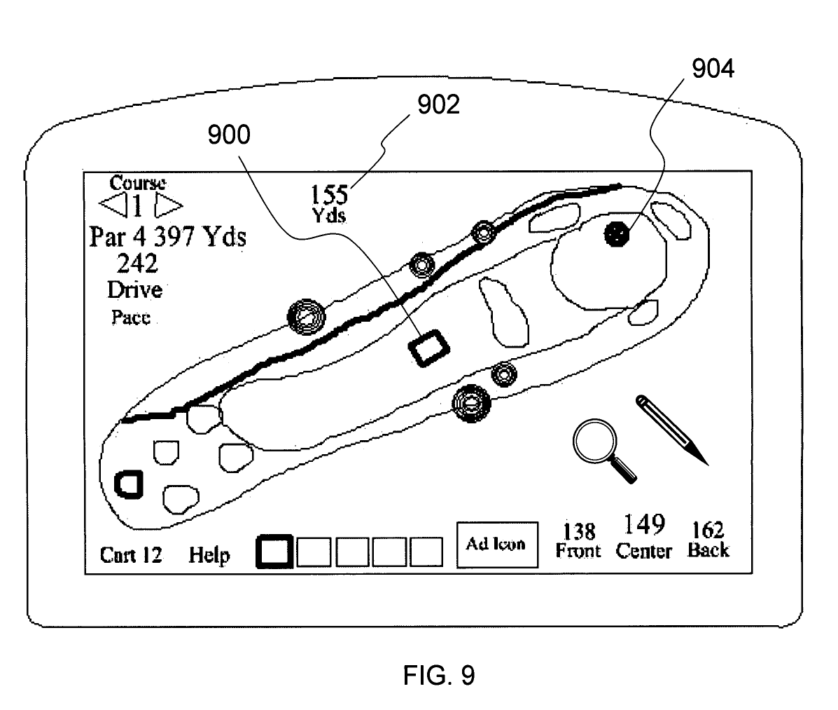

FIG. 9 further expands on the distance calculations by illustrating a technique by which a golfer can determine the yardage 902 from the cart position 900 to the green 904. For example, a user would simply touch the green location 904 on the display which would cause the system to calculate and display the yardage 902 from the cart position 900 to the touched green location 904.

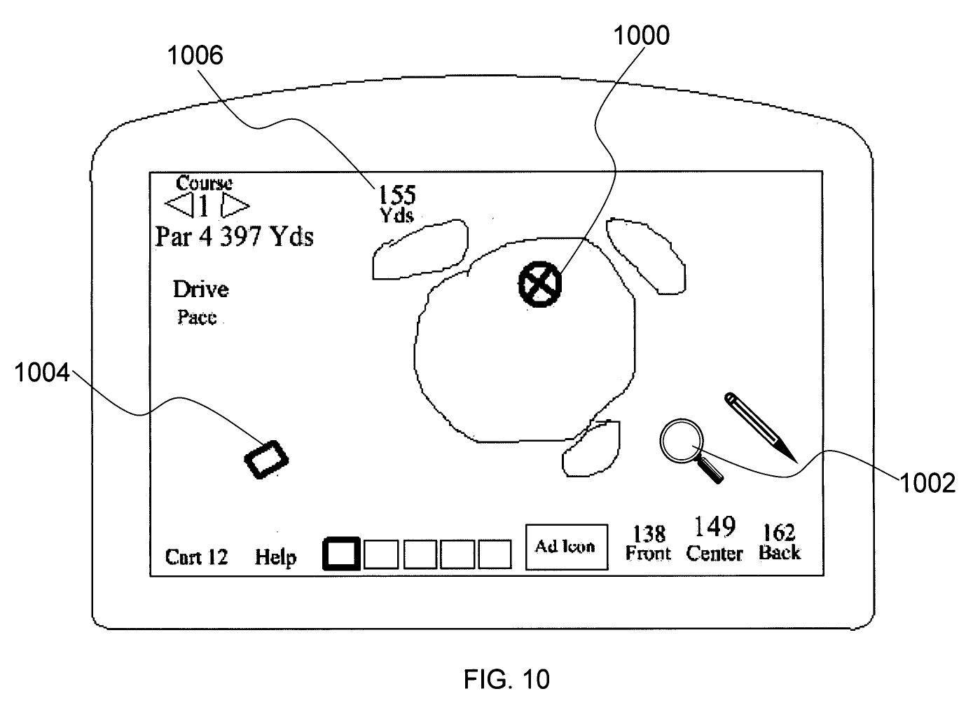

As can be appreciated by one skilled in the art, it may be desirable in some circumstances to zoom into a particular screen shot. For example, FIG. 10 illustrates a zoom to a green location by touching the magnifying glass symbol 1002 to display a zoom image of location 1000 on the green. Referring again to FIG. 9, the user has touched the green location 904 to identify a particular location on the green (e.g., location of the pin). After having touched a particular location, the magnifying glass symbol 1002 can be used to generate the zoom screen depicted in FIG. 10. The zoomed green display will continue to show the previously touched green location from the fairway image. Likewise, a touched location on the zoomed green will be seen on the fairway image in the same location. Additionally, yardage from the cart position 1004 to the location 1000 is displayed by 1006.

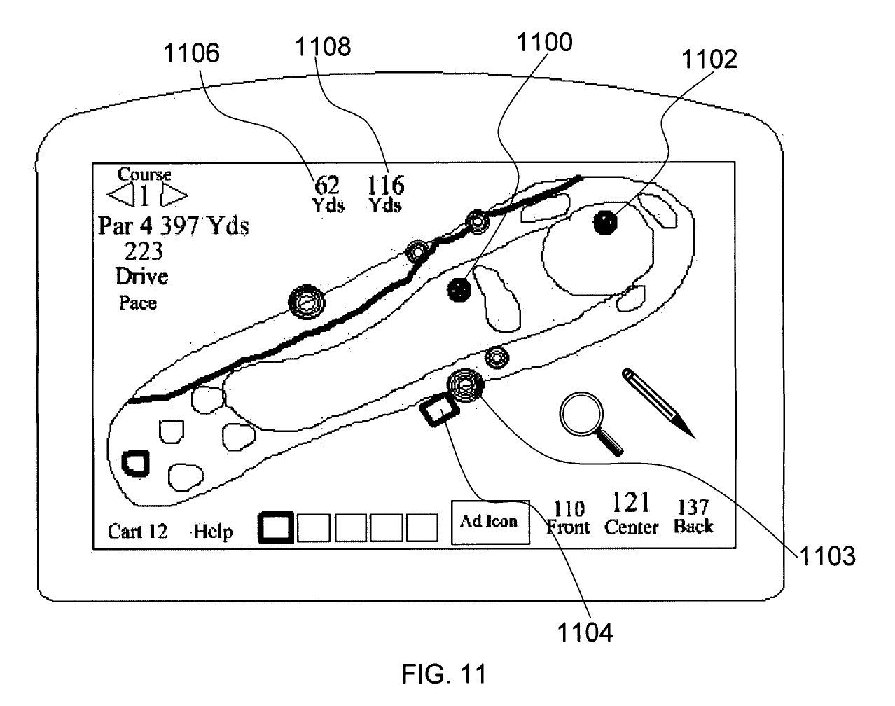

FIG. 11 illustrates pitching a golf ball 62 yards (i.e., pitching yardage 1106) from an undesirable cart location 1104 behind a tree 1103. The pitching yardage 1106 is calculated and displayed by touching location 1100 which displays the pitching yardage 1106 between the cart location 1104 and the touched location 1100. Additionally, by touching location 1102 on the green, the system then calculates and displays the yardage distance 1108 between location 1100 and 1102.

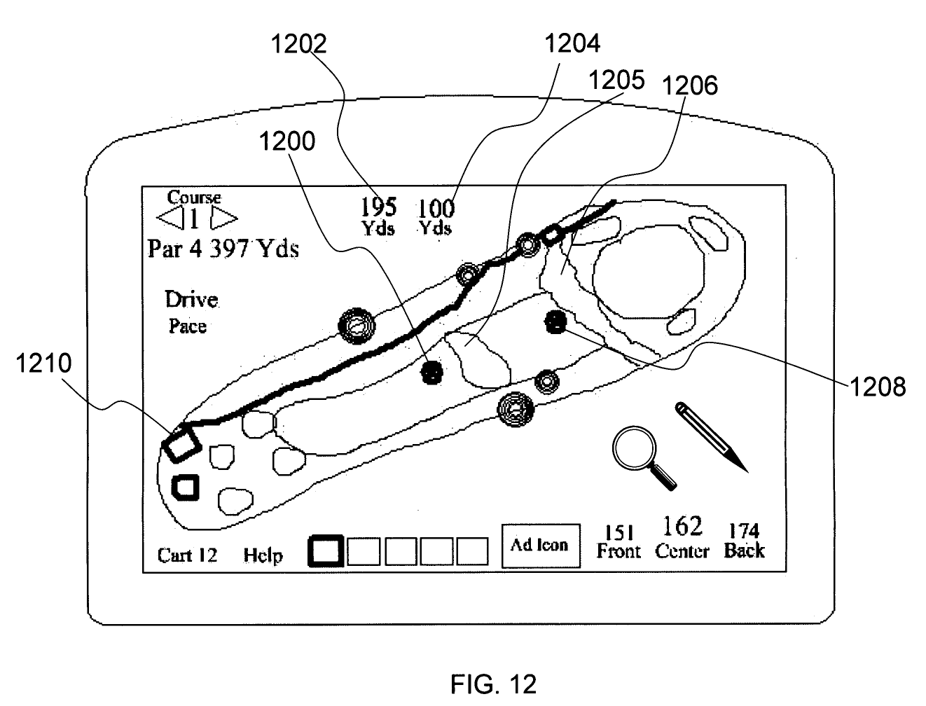

FIG. 12 illustrates a double touch function when encountering more than one hazard on a particular golf hole. For example, a first touch 1200 displays yardage 1202 which represents the distance between cart location 1210 and touch 1200. The first touch 1200 also creates a first marker. This determines a layup position in front of a hazard 1205 and displays the yardage 1202 to assist a user in club selection. A second touch 1208 in front of a second hazard 1206 displays a yardage 1204 to the layup position (i.e., second touch 1208) in front of the second hazard 1206. Thus, by touching an additional point in the displayed area, a second marker appears at that point and the distance from the first marker to the second marker is displayed.

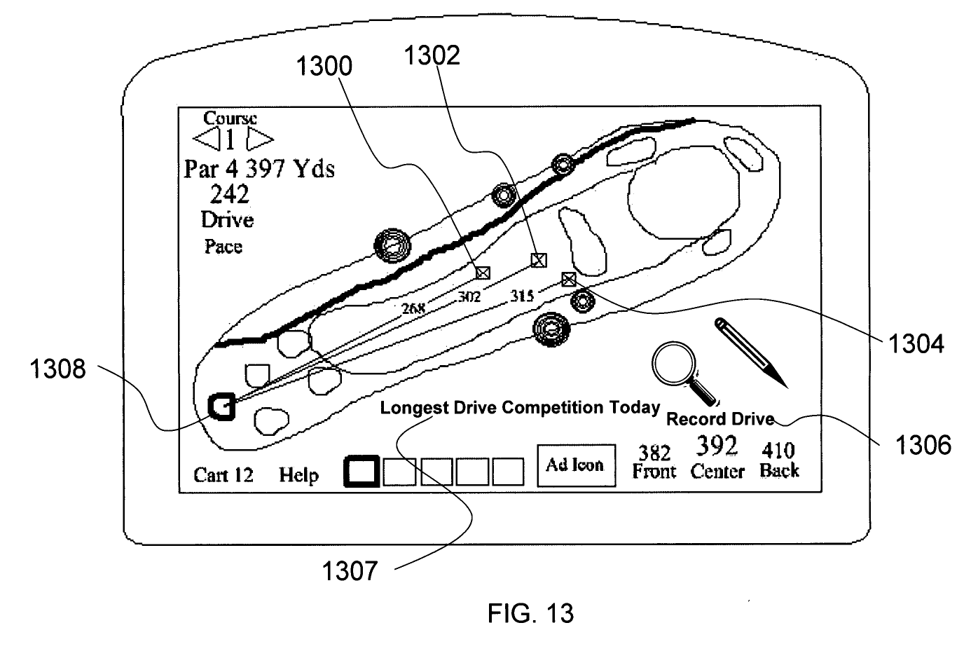

FIG. 13 illustrates a longest drive location which is usually conducted during tournament play. Cart location 1308 is the pre-determined tee box that all players will be playing from during a tournament. Each player in the tournament will have an opportunity to drive their golf ball on a selected hole. The players' ball locations are recorded and displayed for the hole. For example, ball locations 1300, 1302, and 1304 are illustrated as three drive distances of three different players. When approaching a hole where the longest drive is an option, and after teeing off, the golfer then can drive his cart 1308 to his golf ball. After reaching his golf ball, the golfer can record the drive by touching a “Record Drive” icon 1306 which will cause the driving distance to be recorded and transmitted to the Pro Shop for post tournament awards. Additionally, the driving distances can be displayed on the other golfers' displays throughout the course and/or while only on the hole designated for the longest drive. This function can also be used in regular non-tournament play to raise additional revenue. This can be accomplished by merely having golfers sign up, for a fee, to be included in that days “longest drive” competition. On any given day and on any given golf hole, the Pro Shop administrator can turn each carts system on to display text 1307. Other aspects that can be included in this function in addition to “longest drive” are “straightest drive,” and “longest and straightest drive.” By including these features, marginally skilled players can join in the competition.

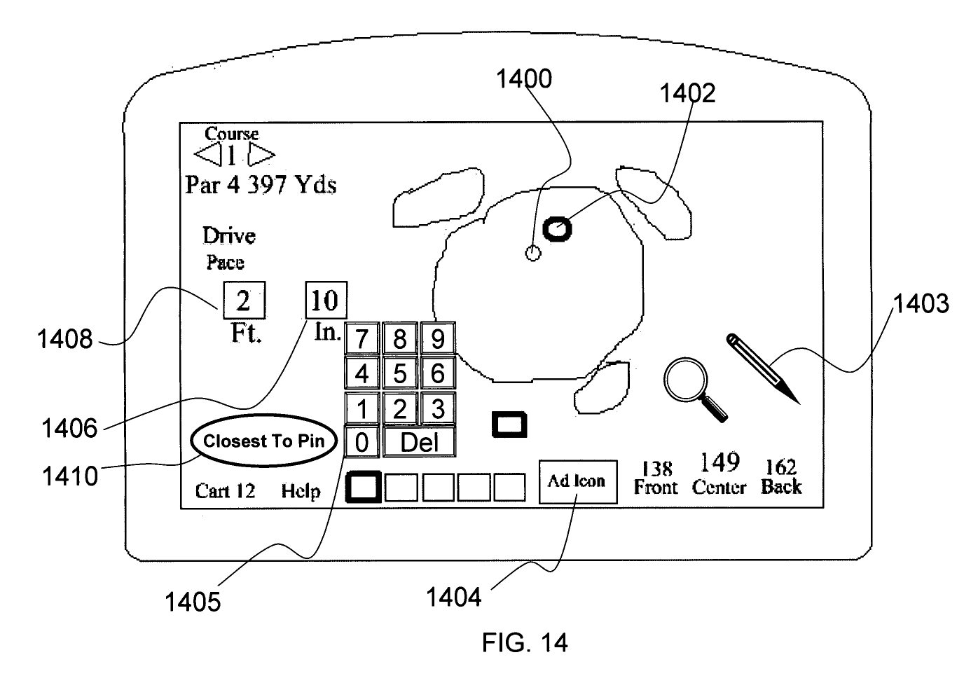

FIG. 14 illustrates a “closest to the pin” contest usually presented during tournament play. Shown as an example is a golf ball 1400 that is close to the cup location 1402. Contestants are provided with a feet/inches measuring tape for measuring distance from the edge of the cup on a straight line to a traditionally marked position of the golf ball 1400. When contestants return to their golf carts, they can record the distance (e.g., feet 1408 and inches 1406) for each golfer in the group with a pop up numeric key pad 1405. The numeric key pad 1405 is retrieved by selecting the scorecard 1403 icon, a closest to pin icon 1410, or any other suitable selection designator. This function can also be initiated on any given day to create additional revenue from fees paid prior to playing a round of golf. It should be noted that the Ad Icon1404 is also present, which upon touching, depicts an enhanced advertisement screen (depicted in FIG. 15).

As noted above, the system provides for various advertisement opportunities and allows for enhanced advertisement screens. For example, FIG. 15 depicts a full screen advertisement 1500 (or enhanced advertisement) that is displayed at various times during a round of golf. The full screen advertisement 1500 can be seen at any time by touching the Ad Icon (depicted as element 1404 in FIG. 14).

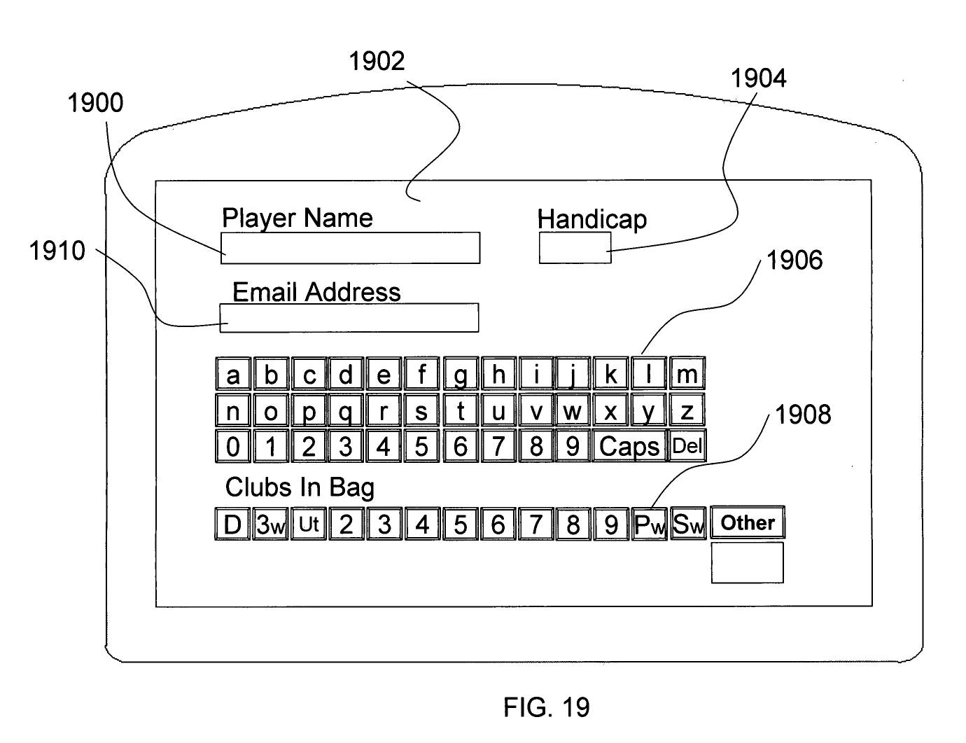

FIG. 16 is an illustration of an electronic scorecard 1603 that is activated/retrieved by touching the scorecard icon (depicted as element 410 in FIG. 14). The electronic scorecard 1603 provides the ability to input names and handicaps from a pop-up alpha numeric keyboard, as depicted in FIG. 19. Also shown is an example of a scorecard advertisement 1600. A numeric key pad 1602 is used to enter scores.

When playing golf, it is often enjoyable to play a game with other players. The system enables a plurality of players to track through scores while playing various games. For example, touching a Games icon 1601 allows golfers to select a game to play during a round of golf, for example, two popular games are Nassau and Skins. The Games icon 1601 also retrieves a screen that allows users to identify which carts are participating in the game (if other players in other carts are playing). Alternatively, the Pro Shop can cluster carts associated with a party for game play. In game mode, the system will keep records of scores recorded and reflect the status of each player in the game.

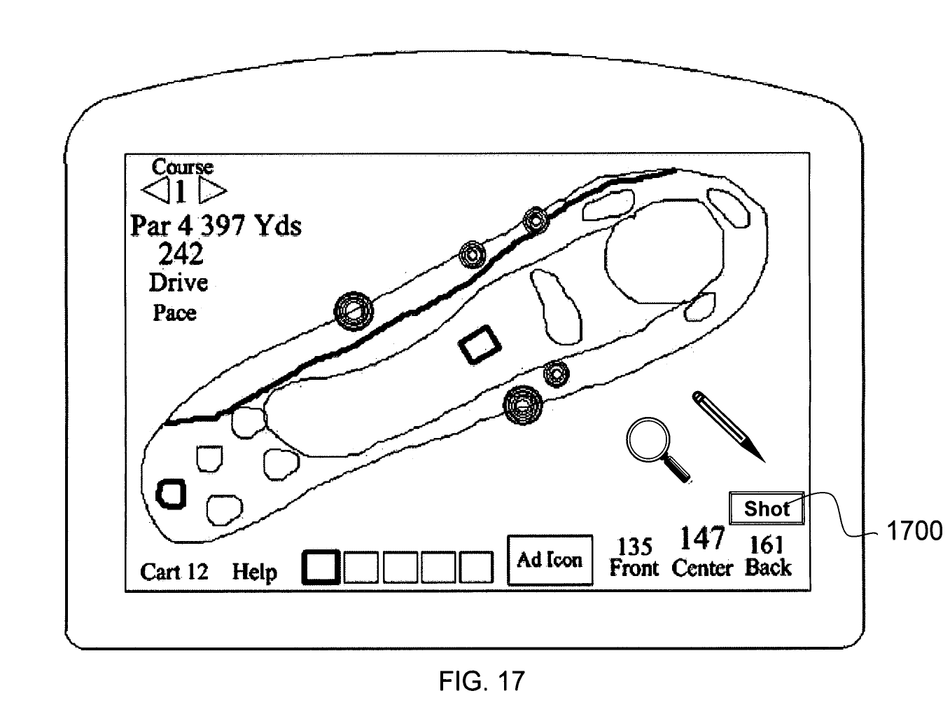

FIG. 17 depicts an option for golfers to use at the start of a round to allow a user to easily record the distances by the club used to execute a particular shot. When a “Shot” record icon 1700 is touched, the system is put into shot recording mode, which allows the user to touch on the touch screen the ball location.

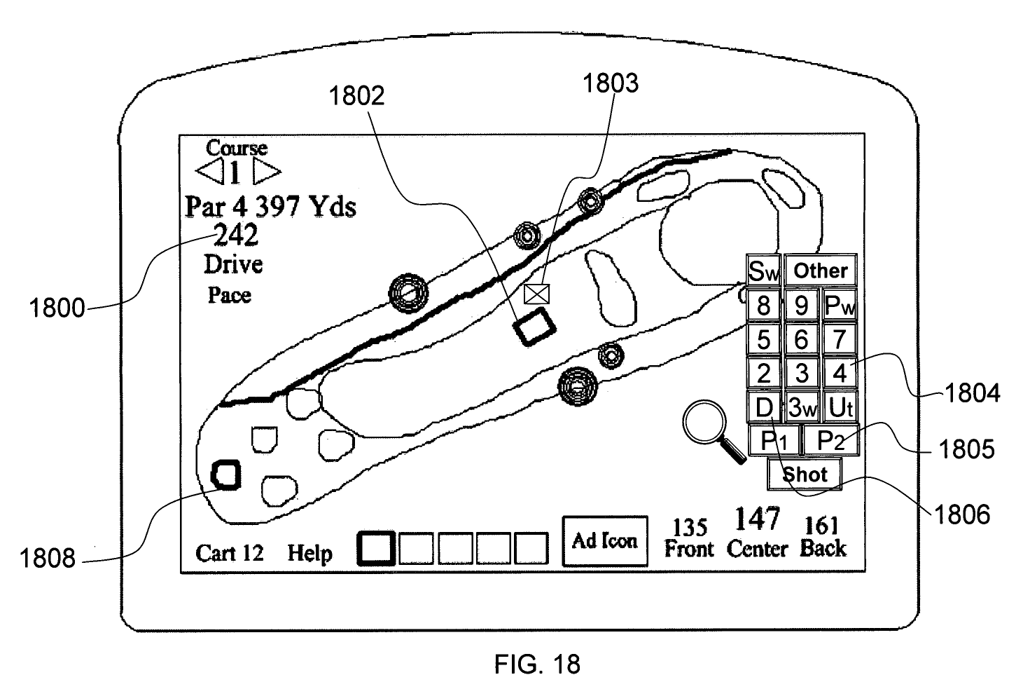

FIG. 18 is an illustration of depicting a user recording a shot. Upon touching the shot recording icon (depicted as element 1700 in FIG. 17), the golfer is provided with a club selection pop-up 1804. A player selection icon 1805 provides a button for player selection. The selected player then touches a location on the golf hole where the ball came to a rest 1803. The next touched club 1806 on the club selection pop-up 1804 records the club that was used to put the ball in position 1803. The system remembers the previous shot recording and records the distance for later use. The first shot recorded for each hole is automatically presumed to be the shot from the tee box.

FIG. 19 is an illustration of a data entry screen 1902. Each golfer can enter their name 1900 and handicap 1904 by touching the alpha numeric key pad 1906. Each player can enter the clubs in their bag by touching the clubs designated by buttons in 1908. Referring to FIG. 18, each player can record their golf shots by use of the club selection pop-up 1804 key pad. The e-mail address field 1910 provides the ability to enter an email address (or other contact information) for each player. For example, at the end of play, the e-mail address can be used to send the player his score, team score, shot distances per club, and other pertinent play information.

FIG. 20 provides a Utility screen 2000 for administrative personnel to place the system in a demonstration mode 2002, calibrate the touch screen 2004, view the number of satellites being acquired 2006 along with signal strength of each satellite, and set the cart number 2008. When the satellites are acquired, the location display 2010 displays all pertinent information received from the satellites, such as the Latitude/Longitude, date and time stamp, number of satellites acquired, and elevation and location of cart position. An Exit button 2012 is provided to migrate the administrative personnel back to the previously viewed screen (or a home screen, etc.).

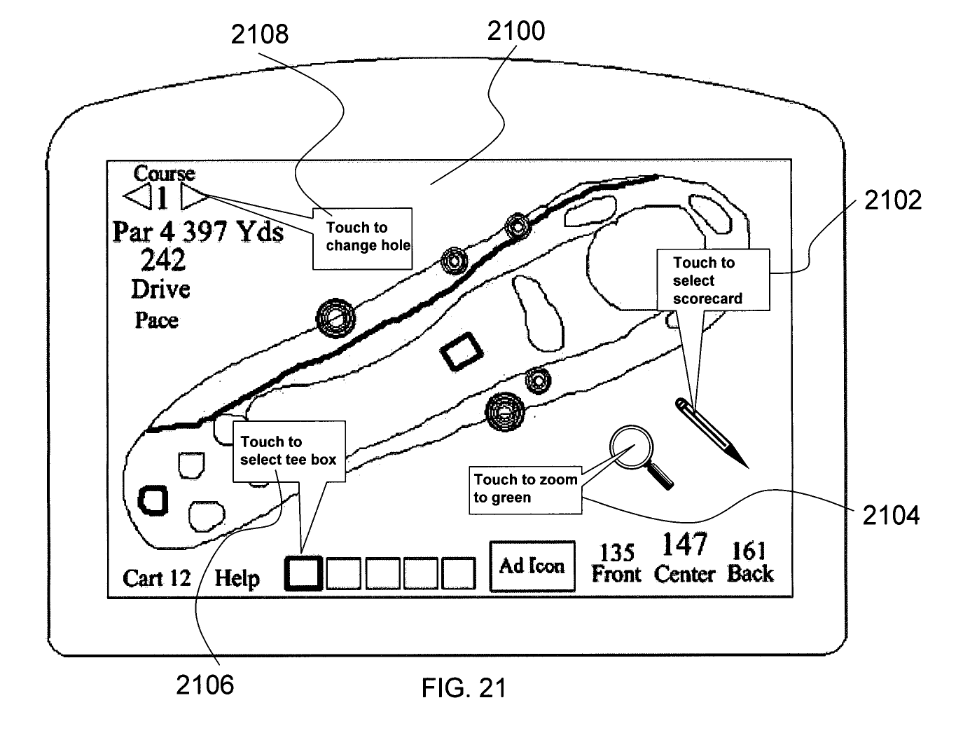

FIG. 21 illustrates a “HELP” screen 2100 detailing functional characteristics. For example, help box 2102 points to a pencil icon that migrates the golfer to the electronic scorecard. Additionally, help box 2104 points to a magnifying glass that migrates the golfer to a zoomed green display, while help box 2106 points to a color coded tee box which allows the golfer to designate up to seven different tee boxes to use during a golf round. Finally, help box 2108 points to an arrow that, when touched, migrates the screen to a hole display either succeeding or preceding the current screen image.

FIG. 2200 is another “HELP” screen that provides additional explanations of various system functions. For example, the help boxes indicate that distance of the touch 2204 is displayed by 2202, while 2206 provides the distance from the position of the golf cart 2208 to the center of the green. Additionally, it also illustrates that drive distance is displayed by 2210.

As noted above, the present invention also monitors the pace of play. The system is configured to monitor the pace of play by determining the appropriate amount of time a cart (and corresponding golfer) should be on a particular hole. As can be appreciated by one skilled in the art, using the GPS system incorporated within the present invention, there are a number of techniques to monitor the pace of play. As a non-limiting example, there is a single entry point (latitude/longitude) that is usually placed in the middle of the cart path approaching the first tee box of each golf hole. This point draws a circle around the point of approximately a five yard radius to accommodate cart entries that are not on the cart path. Once a cart enters the circle, the system recognizes that latitude/longitude associated with the present golf hole. When the circle is penetrated by each golf cart, the internal clock timer starts the “pace of play” for that golf hole for hat golf cart.

When the next hole is started, the elapsed time of play is calculated and compared to the “pace” for the hole, which is permanently stored in the unit and which can is transmitted to the Pro Shop upon being polled by the base station. The difference between the elapsed time and the pace is accumulated for all holes played and displayed for the user as “X minutes behind” or “X minutes ahead” or “On Pace.” The pace for each hole may be individually specified. Pro Shop administrators can set the “pace of play” by increasing or decreasing by a percentage of an established pace for each golf hole. Existing weather conditions determine daily “pace of play” for any given day such as “cart path only” where a round of golf will naturally take longer to play.

(4) Summary

In summary, the present invention improves upon the prior art by providing a touch screen with latitude/longitude per pixel accuracy to provide an interactive system that depicts an actual location of a golfer on a golf course. The system is configured to display an image of each golf hole upon the touch screen. While not limited thereto, each golf hole image provides approximately an eighteen inch distance from pixel-to-pixel. This kind of accuracy, when used over time by a golfer, will lower their scores allow the golfer to touch any location on the golf hole image, get an instant distance display, and select the proper golf club to execute the required shot (by knowing the precise distance to the target selected).

Selecting the proper club and knowing the appropriate distances can be used by teaching professionals to introduce “course management” to their clients. For example, “pace of play” is an extremely critical element in managing a golf course by the course administrators. It is estimated that golfers will be able to increase their pace of play, which is monitored on a display in the Pro Shop, dramatically by eliminating the ever guessing of distances and club selection.

A touch screen scorecard allows easy input of names, handicaps, and scoring to present gross and net scoring. Transmitting this information to the Pro Shop during tournament play will result in compiling tournament scoring results, awarding of longest drive, awarding of straightest drive, awarding of longest and straightest drive, and awarding of “closet to the pin” contests. Besides providing discreet functions for golfers, course managers will reap benefits from increased pace of play and more satisfied golfers. Each course that installs touch screen functionality will benefit from an increased number of rounds on their facility and, ideally, increased revenue.

What is claimed is:

1. A system for attaching with a golf cart and managing play on a golf course, the system comprising:
a touch screen display device;
one or more processors communicatively connected with the touch screen display device, the processor(s) including a global positioning system and being configured to:
determine a location of the golf cart on a golf hole;
display an image of a golf hole;
display a location of the golf cart on the golf hole;
receive a first touch location on the touch screen display device and calculate the corresponding distance on the golf course between the golf cart and the first touch location;
display the distance between the golf cart and the first touch location to a user on the display device, thereby allowing a user to determine shot distance and manage play on the golf course.

2. The system as set forth in claim 1, wherein the processor(s) is further configured to:
receive a second touch location on the touch screen display device and calculate a corresponding distance on the golf course between the first touch location and the second touch location; and
display the distance between the first touch location and the second touch location to a user, thereby allowing a user to selectively determine a distance between two locations on a golf course.

3. The system as set forth in claim 1, wherein the image of the golf hole is an actual aerial image of the golf hole.

4. The system as set forth in claim 1, wherein the processor is further configured to:
display a plurality of tee boxes, each tee box representing an actual tee box on the golf hole;
receive a selection from a user designating one of the plurality of the tee boxes as a selected tee box;
calculate a distance from the selected tee box to a pin hole; and
display the distance to the user.

5. The system as set forth in claim 1, wherein one or more processors are further configured to:
receive input from a plurality of users designating a golf ball drive location for each of the plurality of users from a designated tee box;
calculate a distance between the designated tee box and the golf ball drive location for each of the plurality of users, the distance being a driving distance; and
select the longest driving distance and display the longest driving distance to each of the plurality of users in their corresponding display devices.

6. The system as set forth in claim 1, wherein one or more processors are further configured to:
receive input from a plurality of users designating a golf ball drive location for each of the plurality of users from a designated tee box to a particular pin hole;
calculate a distance between the golf ball drive location for each of the plurality of users and the particular pin hole, the distance being a distance-to-pin; and
select the shortest distance-to-pin and display the shortest distance-to-pin to each of the plurality of users in their corresponding display devices.

7. The system as set forth in claim 1, wherein the image of the golf hole is an actual aerial image of the golf hole;
wherein the processor is further configured to:
display a plurality of tee boxes, each tee box representing an actual tee box on the golf hole;
receive a selection from a user designating one of the plurality of the tee boxes as a selected tee box;
calculate a distance from the selected tee box to a pin hole; and
display the distance to the user; and
wherein one or more processors are further configured to:
receive input from a plurality of users designating a golf ball drive location for each of the plurality of users from a designated tee box;
calculate a distance between the designated tee box and the golf ball drive location for each of the plurality of users, the distance being a driving distance; and
select the longest driving distance and display the longest driving distance to each of the plurality of users in their corresponding display devices; and
wherein one or more processors are further configured to:
receive input from a plurality of users designating a golf ball drive location for each of the plurality of users from a designated tee box to a particular pin hole;
calculate a distance between the golf ball drive location for each of the plurality of users and the particular pin hole, the distance being a distance-to-pin; and
select the shortest distance-to-pin and display the shortest distance-to-pin to each of the plurality of users in their corresponding display devices.

8. A method for managing play on a golf course, comprising acts of:
causing a processor to determine a location of a golf cart on a golf hole;
displaying an image of a golf hole on a touch screen display;
displaying a location of the golf cart on the golf hole;
receiving a first touch location on the touch screen display device and calculating the corresponding distance on the golf course between the golf cart and the first touch location; and
displaying the distance between the golf cart and the first touch location to a user on the display device, thereby allowing a user to determine shot distance and manage play on the golf course.

9. The method as set forth in claim 8, further comprising acts of:
receiving a second touch location on the touch screen display device and calculating a corresponding distance on the golf course between the first touch location and the second touch location; and
displaying the distance between the first touch location and the second touch location to a user, thereby allowing a user to selectively determine a distance between two locations on a golf course.

10. The method as set forth in claim 8, wherein in displaying an image of the golf hole, the image of the golf hole is an actual aerial image of the golf hole.

11. The method as set forth in claim 8, further comprising acts of:
displaying a plurality of tee boxes, each tee box representing an actual tee box on the golf hole;
receiving a selection from a user designating one of the plurality of the tee boxes as a selected tee box;
calculating a distance from the selected tee box to a pin hole; and
displaying the distance to the user.

12. The method as set forth in claim 8, further comprising acts of:
receiving input from a plurality of users designating a golf ball drive location for each of the plurality of users from a designated tee box;
calculating a distance between the designated tee box and the golf ball drive location for each of the plurality of users, the distance being a driving distance; and
selecting the longest driving distance and displaying the longest driving distance to each of the plurality of users in their corresponding display devices.

13. The method as set forth in claim 8, further comprising acts of:
receiving input from a plurality of users designating a golf ball drive location for each of the plurality of users from a designated tee box to a particular pin hole;
calculating a distance between the golf ball drive location for each of the plurality of users and the particular pin hole, the distance being a distance-to-pin; and
selecting the shortest distance-to-pin and displaying the shortest distance-to-pin to each of the plurality of users in their corresponding display devices.

14. The method as set forth in claim 8, further comprising acts of:
displaying the image of the golf hole as an actual aerial image of the golf hole;
displaying a plurality of tee boxes, each tee box representing an actual tee box on the golf hole;
receiving a selection from a user designating one of the plurality of the tee boxes as a selected tee box;
calculating a distance from the selected tee box to a pin hole and displaying the distance to the user;
receiving input from a plurality of users designating a golf ball drive location for each of the plurality of users from a designated tee box;
calculating a distance between the designated tee box and the golf ball drive location for each of the plurality of users, the distance being a driving distance; and
selecting the longest driving distance and displaying the longest driving distance to each of the plurality of users in their corresponding display devices;
receiving input from a plurality of users designating a golf ball drive location for each of the plurality of users from a designated tee box to a particular pin hole;
calculating a distance between the golf ball drive location for each of the plurality of users and the particular pin hole, the distance being a distance-to-pin; and
selecting the shortest distance-to-pin and displaying the shortest distance-to-pin to each of the plurality of users in their corresponding display devices.

15. A computer program product for managing play on a golf course, the computer program product comprising computer-readable instruction means stored on a computer-readable medium that are executable by a computer having a processor for causing the processor to perform operations of:
determining a location of a golf cart on a golf hole;
displaying an image of a golf hole;
displaying a location of the golf cart on the golf hole;
receiving a first touch location on the touch screen display device and calculating the corresponding distance on the golf course between the golf cart and the first touch location; and
displaying the distance between the golf cart and the first touch location to a user on the display device, thereby allowing a user to determine shot distance and manage play on the golf course.

16. The computer program product as set forth in claim 15, further comprising instruction means for causing a computer to perform operations of:
receiving a second touch location on the touch screen display device and calculating a corresponding distance on the golf course between the first touch location and the second touch location; and
displaying the distance between the first touch location and the second touch location to a user, thereby allowing a user to selectively determine a distance between two locations on a golf course.

17. The computer program product as set forth in claim 15, further comprising instruction means for causing one or more processors to perform operations of:
displaying a plurality of tee boxes, each tee box representing an actual tee box on the golf hole;
receiving a selection from a user designating one of the plurality of the tee boxes as a selected tee box;
calculating a distance from the selected tee box to a pin hole; and
displaying the distance to the user.

18. The computer program product as set forth in claim 15, further comprising instruction means for causing one or more processors to perform operations of:
receiving input from a plurality of users designating a golf ball drive location for each of the plurality of users from a designated tee box;
calculating a distance between the designated tee box and the golf ball drive location for each of the plurality of users, the distance being a driving distance; and
selecting the longest driving distance and displaying the longest driving distance to each of the plurality of users in their corresponding display devices.

19. The computer program product as set forth in claim 15, further comprising instruction means for causing one or more processors to perform operations of:
receiving input from a plurality of users designating a golf ball drive location for each of the plurality of users from a designated tee box to a particular pin hole;
calculating a distance between the golf ball drive location for each of the plurality of users and the particular pin hole, the distance being a distance-to-pin; and
selecting the shortest distance-to-pin and displaying the shortest distance-to-pin to each of the plurality of users in their corresponding display devices.

20. The computer program product as set forth in claim 15, further comprising instruction means for causing one or more processors to perform operations of:
displaying the image of the golf hole as an actual aerial image of the golf hole;
displaying a plurality of tee boxes, each tee box representing an actual tee box on the golf hole;
receiving a selection from a user designating one of the plurality of the tee boxes as a selected tee box;
calculating a distance from the selected tee box to a pin hole and displaying the distance to the user;
receiving input from a plurality of users designating a golf ball drive location for each of the plurality of users from a designated tee box;
calculating a distance between the designated tee box and the golf ball drive location for each of the plurality of users, the distance being a driving distance; and
selecting the longest driving distance and displaying the longest driving distance to each of the plurality of users in their corresponding display devices;
receiving input from a plurality of users designating a golf ball drive location for each of the plurality of users from a designated tee box to a particular pin hole;
calculating a distance between the golf ball drive location for each of the plurality of users and the particular pin hole, the distance being a distance-to-pin; and
selecting the shortest distance-to-pin and displaying the shortest distance-to-pin to each of the plurality of users in their corresponding display devices.
